(19) United States
(12) Patent Application Publication
(10) Pub. No.: US 2015/0052374 A1
(43) Pub. Date: Feb. 19, 2015

(54) DATA STORAGE DEVICE AND DATA PROCESSING SYSTEM INCLUDING THE SAME

(71) Applicant: SK hynix Inc., Icheon-si (KR)

(72) Inventor: Won Kyung KANG, Icheon-si (KR)

(73) Assignee: SK hynix Inc., Icheon-si (KR)

(21) Appl. No.: 14/093,321

(22) Filed: Nov. 29, 2013

(30) Foreign Application Priority Data
Aug. 19, 2013 (KR) 10-2013-0097804

(51) Int. Cl. G06F 1/32

(52) U.S. Cl. CPC G06F 1/3287
USPC 713/323

(57) ABSTRACT

A data processing system includes a host device; and a data storage device including an interface unit which is configured to interface with the host device, and configured to store data provided from the host device or provide data to the host device, in response to a request from the host device, wherein the data storage device is configured to interrupt power supply to the interface unit while the host device operates in a power saving mode.

### CROSS-REFERENCES TO RELATED APPLICATION

The present application claims priority under 35 U.S.C. §119(a) to Korean application number 10-2013-0097804, filed on Aug. 19, 2013, in the Korean Intellectual Property Office, which is incorporated herein by reference in its entirety.

### BACKGROUND

1. Technical Field

Various embodiments generally relate to a data processing system, and more particularly, to a data storage device capable of reducing power consumption in a power saving state and a data processing system including the same.

2. Related Art

Recently, the paradigm for the computer environment has been converted into ubiquitous computing so that computer systems can be used anytime and anywhere. Due to this fact, the use of portable electronic devices such as mobile phones, digital cameras, and notebook computers has rapidly increased. In general, such portable electronic devices use a data storage device which uses a memory device. The data storage device is used as a main memory device or an auxiliary memory device of a portable electronic device.

A data storage device using a memory device provides advantages in that, since there is no mechanical driving part, stability and durability are excellent, an information access speed is high and power consumption is small. Data storage devices having such advantages include an universal serial bus (USB) memory device, a memory card having various interfaces, and a solid state drive (SSD).

A data storage device may internally perform an operation in response to a request from a host device. Further, the data storage device may operate in a power saving state or an idle state when no request is made from the host device. In an aspect of managing the power of an entire data processing system, it is important to control the data storage device to consume a minimum amount of power while operating in a power saving state.

### SUMMARY

A data storage device capable of reducing power consumption and a data processing system including the same are described herein.

In an embodiment of the present invention, a data processing system includes: a host device; and a data storage device including an interface unit which is configured to interface with the host device, and configured to store data provided from the host device or provide data to the host device, in response to a request from the host device, wherein the data storage device is configured to interrupt power supply to the interface unit while the host device operates in a power saving mode.

In an embodiment of the present invention, a data storage device includes: a nonvolatile memory device; a controller configured to store data provided from a host device, in the nonvolatile memory device, or provide data read from the nonvolatile memory device, to the host device, in response to a request from the host device; an interface unit configured to interface the host device and the controller; and a power supplier configured to supply power to the nonvolatile memory device, the controller and the interface unit according to control of the controller, wherein the controller is configured to control the power supplier in such a manner that power supply to the interface unit is interrupted while operating in a power saving mode.

In an embodiment of the present invention, a data storage device includes: a nonvolatile memory device; a controller configured to store data provided from a host device, in the nonvolatile memory device, or provide data read from the nonvolatile memory device, to the host device, in response to a request from the host device; and an interface unit including a power block for generating power to be internally used, and configured to interface the host device and the controller, wherein the controller is configured to control the power block in such a manner that power supply to the interface unit is interrupted while operating in a power saving mode.

According to embodiments of the present disclosure, since it is possible to reduce power consumption of a data storage device which operates in a power saving state, the power consumption of a data processing system may be reduced.

### BRIEF DESCRIPTION OF THE DRAWINGS

Features, aspects, and embodiments are described in conjunction with the attached drawings, in which:

FIG. 1 is a block diagram illustrating a data processing system in accordance with an embodiment of the present disclosure;

FIG. 2 is a block diagram illustrating an example of the interface unit and the power supplier included in the data storage device of FIG. 1;

FIG. 3 is a timing diagram for explaining operations of the data processing system of FIG. 1;

FIG. 4 is a block diagram illustrating a data processing system in accordance with an embodiment of the present disclosure;

FIG. 5 is a block diagram illustrating an example of the interface unit included in the data storage device of FIG. 4;

FIG. 6 is a timing diagram for explaining operations of the data processing system of FIG. 4;

FIG. 7 is a block diagram illustrating a data processing system in accordance with an embodiment of the present disclosure;

FIG. 8 is a block diagram illustrating an example of the interface unit and the power supplier included in the data storage device of FIG. 7;

FIG. 9 is a timing diagram for explaining operations of the data processing system of FIG. 7;

FIG. 10 is a block diagram illustrating a data processing system in accordance with an embodiment of the present disclosure;

FIG. 11 is a block diagram illustrating an example of the interface unit included in the data storage device of FIG. 10; and

FIG. 12 is a timing diagram for explaining operations of the data processing system of FIG. 10.

### DETAILED DESCRIPTION

In the present invention, advantages, features and methods for achieving them will become more apparent after a reading of the following examples of the embodiments taken in conjunction with the drawings. The present invention may, however, be embodied in different forms and should not be construed as being limited to the embodiments set forth herein. Rather, these embodiments are provided to describe the present invention in detail to the extent that a person skilled in the art to which the invention pertains can easily enforce the technical concept of the present invention.

It is to be understood herein that embodiments of the present invention are not limited to the particulars shown in the drawings and that the drawings are not necessarily to scale and in some instances proportions may have been exaggerated in order to more clearly depict certain features of the invention. While particular terminology is used herein, it is to be appreciated that the terminology used herein is for the purpose of describing particular embodiments only and is not intended to limit the scope of the present invention.

As used herein, the term “and/or” includes any and all combinations of one or more of the associated listed items. It will be understood that when an element is referred to as being “on,” “connected to” or “coupled to” another element, it may be directly on, connected or coupled to the other element or intervening elements may be present. As used herein, a singular form is intended to include plural forms as well, unless the context clearly indicates otherwise. It will be further understood that the terms “includes” and/or “including,” when used in this specification, specify the presence of at least one stated feature, step, operation, and/or element, but do not preclude the presence or addition of one or more other features, steps, operations, and/or elements thereof.

Hereinafter, a data storage device and a data processing system including the same according to the present invention will be described below with reference to the accompanying drawings through various examples of embodiments.

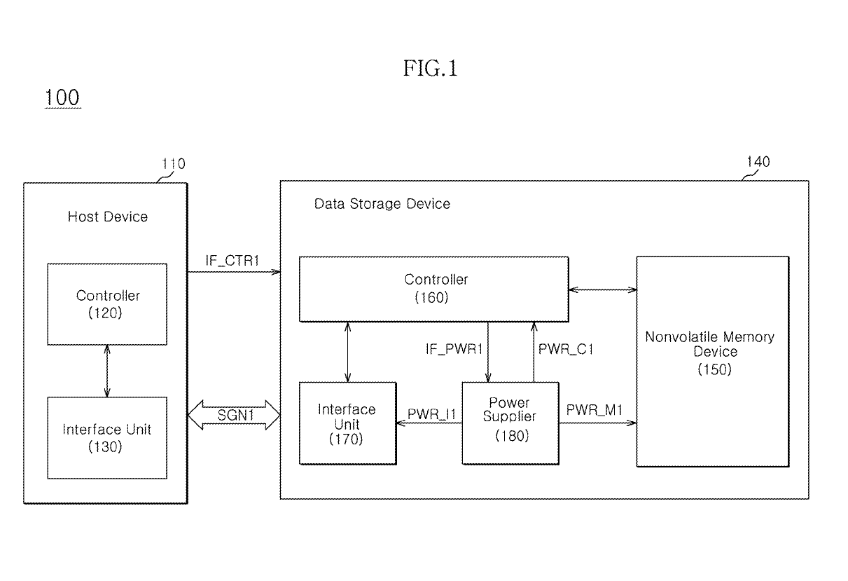

FIG. 1 is a block diagram showing an example of a data processing system in accordance with an embodiment of the present disclosure. Referring to FIG. 1, a data processing system 100 may include a host device 110, and a data storage device 140.

For instance, the host device 110 may include portable electronic devices such as a mobile phone, an MP3 player, a digital camera and a laptop computer, or electronic devices such as a desktop computer, a game player, a TV, a beam projector and a car entertainment system.

The host device 110 may include a controller 120 and an interface unit 130. While it is shown that the interface unit 130 is disposed outside the controller 120, it is to be noted that the interface unit 130 may be included in the controller 120.

The controller 120 may be configured to control the general operations of the host device 110. The controller 120 may control the general operations of the host device 110 through driving of a firmware or a software which is loaded on a working memory device (not shown).

The interface unit 130 may be configured to interface the host device 110 and the data storage device 140. For instance, the interface unit 130 may perform an interfacing function through one of various interface protocols such as an universal flash storage (UFS) protocol, an universal serial bus (USB) protocol, a multimedia card (MMC) protocol, a peripheral component interconnection (PCI) protocol, a PCI-express (PCI-E) protocol, a parallel advanced technology attachment (PATA) protocol, a serial advanced technology attachment (SATA) protocol, a small computer system interface (SCSI) protocol, and a serial attached SCSI (SAS) protocol.

The controller 120 may be configured to provide an access request (for example, a write request) and data to the data storage device 140, to store data in the data storage device 140. The controller 120 may be configured to provide an access request (for example, a read request) to the data storage device 140, to read data stored in the data storage device 140, and may be configured to be provided with data from the data storage device 140. Also, the controller 120 may be configured to provide various control requests for controlling the data storage device 140, which are not associated with the input and output of data, to the data storage device 140. Such access requests, data and control requests may be transferred to the data storage device 140 according to the protocol of the interface unit 130. Such access requests, data and control requests may be transmitted through a signal line SGN1 between the interface unit 130 of the host device 110 and an interface unit 170 of the data storage device 140.

The controller 120 may control the power saving mode of the host device 110. That is to say, the controller 120 may control the host device 110 to enter a power saving mode such as a sleep mode and a power-down mode when there is no task to be processed.

When the host device 110 enters the power saving mode, the controller 120 may control the data storage device 140 to also enter a power saving mode. For instance, the controller 120 may provide a power saving mode entry request as one of the control requests, to the data storage device 140. Further, when the host device 110 enters the power saving mode, the controller 120 may provide an interface control signal IF_CTR1 to the data storage device 140. Power supply to the interface unit 170 of the data storage device 140 may be interrupted by the interface control signal IF_CTR1.

The data storage device 140 may be configured to operate in response to a request from the host device 110. The data storage device 140 may be configured to store the data accessed by the host device 110. In other words, the data storage device 140 may be used as a memory device of the host device 110.

The data storage device 140 may be fabricated as any one of various kinds of storage devices, according to the protocol of the interface unit 170. For example, the data storage device 140 may be configured as any one of various kinds of storage devices such as a solid state drive, a multimedia card in the form of an MMC, an eMMC, an RS-MMC and a micro-MMC, a secure digital card in the form of an SD, a mini-SD and a micro-SD, an universal serial bus (USB) storage device, an universal flash storage (UFS) device, a personal computer memory card international association (PCMCIA) card, a compact flash (CF) card, a smart media card, and a memory stick.

The data storage device 140 may be fabricated as any one of various kinds of packages. For example, the data storage device 140 may be fabricated as any one of various kinds of package types such as a package on package (POP), a system in package (SIP), a system on chip (SOC), a multi-chip package (MCP), a chip on board (COB), a wafer-level fabricated package (WFP), and a wafer-level stack package (WSP).

The data storage device 140 may include a nonvolatile memory device 150, a controller 160, the interface unit 170, and a power supplier 180. While it is shown that the interface unit 170 and the power supplier 180 are disposed outside the controller 160, it is to be noted that the interface unit 170 and the power supplier 180 may be included in the controller 160.

The nonvolatile memory device 150 may operate as the storage medium of the data storage device 140. The nonvolatile memory device 150 may be constituted by any one of various types of nonvolatile memory devices such as a NAND type flash memory device, a NOR type flash memory device, a ferroelectric random access memory (FRAM) device using ferroelectric capacitors, a magnetic random access memory (MRAM) device using a tunneling magneto-resistive (TMR) layer, a phase change random access memory (PRAM) device using a chalcogenide alloy, and a resistive random access memory (ReRAM) device using a transition metal oxide. The nonvolatile memory device 150 may be constituted by a combination of a NAND type flash memory device and one or more of the various types of nonvolatile memory devices described above.

The controller 160 may be configured to control the general operations of the data storage device 140. The controller 160 may control the general operations of the data storage device 140 through driving of a firmware or a software which is loaded on a working memory device (not shown). The controller 160 may be configured to control the nonvolatile memory device 150 in response to a request from the host device 110. For example, the controller 160 may be configured to control the read, program (or write) and erase operations of the nonvolatile memory device 150.

The interface unit 170 may be configured to interface the data storage device 140 and the host device 110. For instance, the interface unit 170 may perform an interfacing function through the same protocol as the protocol of the interface unit 130 of the host device 110.

The power supplier 180 may be configured to provide the external power inputted from an external device, to the inside of the data storage device 140. For example, the power supplier 180 may supply controller power PWR_C1 generated on the basis of the external power, to the controller 160. The power supplier 180 may supply memory power PWR_M1 generated on the basis of the external power, to the nonvolatile memory device 150. Moreover, the power supplier 180 may supply interface power PWR_I1 generated on the basis of the external power, to the interface unit 170.

The power supplier 180 may supply or interrupt the interface power PWR_I1 in response to an interface power signal IF_PWR1 which is provided from the controller 160. For example, the power supplier 180 may supply the interface power PWR_I1 to the interface unit 170 when the interface power signal IF_PWR1 is activated. In other examples, the power supplier 180 may interrupt the supply of the interface power PWR_I1 when the interface power signal IF_PWR1 is deactivated.

If the host device 110 activates the interface control signal IF_CTR1 when the operation of the interface unit 170 is not necessary, the controller 160 may deactivate the interface power signal IF_PWR1 according to the interface control signal IF_CTR1. Namely, the interface power signal IF_PWR1 may be provided to the power supplier 180 according to the interface control signal IF_CTR1 which is provided when the host device 110 operates at the power saving mode. This means that, while the host device 110 and the data storage device 140 operate at the power saving mode, power supply to the interface unit 170 is interrupted and thus the power consumed by the interface unit 170 may be reduced.

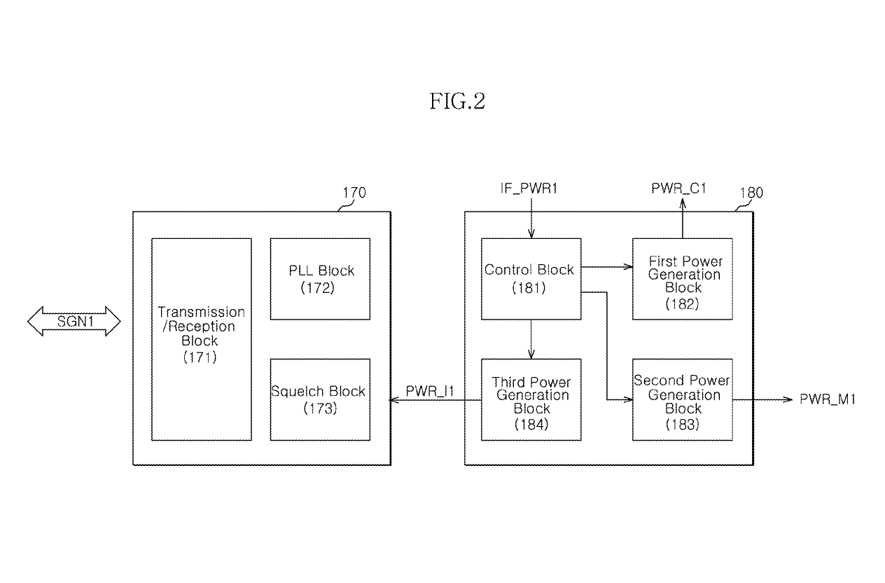

FIG. 2 is a block diagram showing examples of the interface unit and the power supplier included in the data storage device of FIG. 1.

The interface unit 170 may include a transmission/reception block 171, a phase-locked loop (PLL) block 172, and a squelch block 173.

The transmission/reception block 171 may be configured to generate a signal to be transmitted through the signal line SGN1 for signal transmission to the interface unit 130 of the host device 110, and transmit the generated signal. Also, the transmission/reception block 171 may be configured to receive the signal transmitted through the signal line SGN1.

The PLL block 172 may be configured to generate a clock which is needed for the signal transmission of the interface unit 170.

The squelch block 173 may be configured to sense the voltage level of the signal transmitted through the signal line SGN1, and determine whether the transmitted signal is a valid signal or an invalid signal (for example, noise), according to a sensing result.

The transmission/reception block 171, the PLL block 172 and the squelch block 173 may be physical blocks which include analog circuits. For this reason, the interface unit 170 may be referred to as a PHY unit (or a PHY block).

The power supplier 180 may include a control block 181, a first power generation block 182, a second power generation block 183, and a third power generation block 184.

The control block 181 may be configured to control the first power generation block 182 according to a control signal (not shown) provided from the controller 160. The first power generation block 182 may be configured to generate the controller power PWR_C1 according to the control of the control block 181, and supply the generated controller power PWR_C1 to the controller 160.

The control block 181 may be configured to control the second power generation block 183 according to a control signal (not shown) provided from the controller 160. The second power generation block 183 may be configured to generate the memory power PWR_M1 according to the control of the control block 181, and supply the generated memory power PWR_M1 to the nonvolatile memory device 150.

The control block 181 may be configured to control the third power generation block 184 according to the interface power signal IF_PWR1 provided from the controller 160. The third power generation block 184 may be configured to generate the interface power PWR_I1 when the interface power signal IF_PWR1 is activated, and supply the generated interface power PWR_I1 to the interface unit 170. The third power generation block 184 not only may not generate the interface power PWR_I1 but also may interrupt the supply of the interface power PWR_I1, when the interface power signal IF_PWR1 is deactivated.

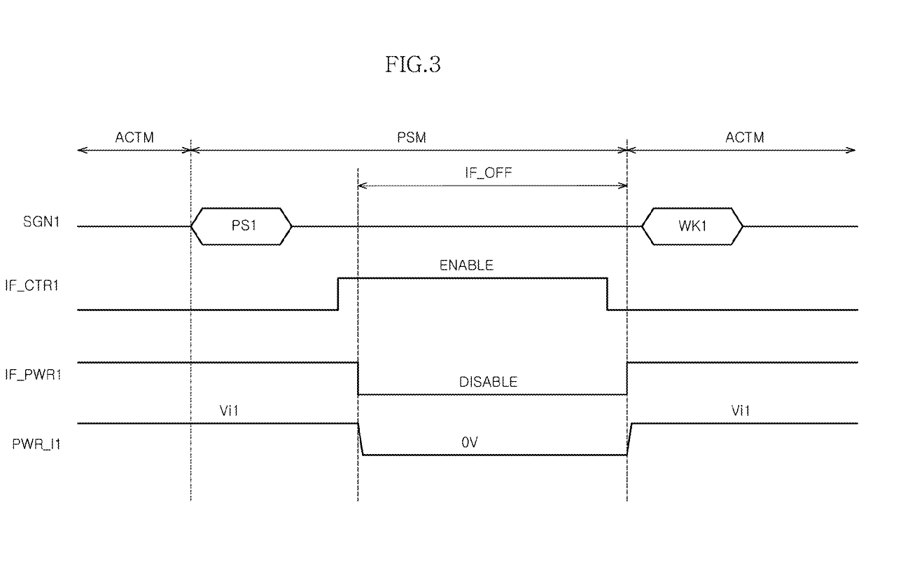

FIG. 3 is a timing diagram explaining operations of the data processing system of FIG. 1. The waveforms of control signals and power in the case where the host device 110 and the data storage device 140 operate in an active mode ACTM and a power saving mode PSM will be described below with reference to FIGS. 1 to 3.

In the case where the host device 110 is converted from the active mode ACTM into the power saving mode PSM, the controller 120 of the host device 110 may provide a power saving mode entry request PS1 to the data storage device 140. The power saving mode entry request PS1 may be provided in the form of a command through the signal line SGN1.

After the controller 120 of the host device 110 provides the power saving mode entry request PS1, it may activate (i.e., ENABLE) the interface control signal IF_CTR1 to reduce the power consumed by the interface unit 170 of the data storage device 140. Further, the controller 120 of the host device 110 may provide the activated interface control signal IF_CTR1 to the data storage device 140.

The controller 160 of the data storage device 140 may deactivate (i.e., DISABLE) the interface power signal IF_PWR1 when the activated interface control signal IF_CTR1 is provided. Also, the controller 160 of the data storage device 140 may provide the deactivated interface power signal IF_PWR1 to the power supplier 180.

When the deactivated interface power signal IF_PWR1 is provided, the power supplier 180 not only may not generate the interface power PWR_I1 (for instance, 0V is shown), but also may interrupt the interface power PWR_I1 being supplied to the interface unit 170. While the interface power PWR_I1 is shown as a voltage value (Vi1 or a ground voltage of 0V) in FIG. 3, the interface power PWR_I1 may mean a voltage or current value. If the interface power PWR_I1 supplied to the interface unit 170 is interrupted as in a period IF_OFF, since the interface unit 170 does not operate any more, the power consumed while the host device 110 and the data storage device 140 operate in the power saving mode PSM may be reduced.

In the case where the host device 110 is converted from the power saving mode PSM into the active mode ACTM, the controller 120 of the host device 110 may provide an active mode entry request WK1 to the data storage device 140. The active mode entry request WK1 may be provided in the form of a command through the signal line SGN1.

At the same time (or after) the controller 120 of the host device 110 provides the active mode entry request WK1, it may deactivate the interface control signal IF_CTR1 to allow the interface unit 170 of the data storage device 140 to operate. Further, the controller 120 of the host device 110 may provide the deactivated interface control signal IF_CTR1 to the data storage device 140.

The controller 160 of the data storage device 140 may activate the interface power signal IF_PWR1 when the deactivated interface control signal IF_CTR1 is provided. Also, the controller 160 of the data storage device 140 may provide the activated interface power signal IF_PWR1 to the power supplier 180.

When the activated interface power signal IF_PWR1 is provided, the power supplier 180 may generate the interface power PWR_I1, and may supply the generated interface power PWR_I1 to the interface unit 170.

Although not shown, if the power saving mode entry request PS1 is provided to the data storage device 140, the power supplier 180 may be changed to a power saving state or a standby state according to the control of the controller 160. As the power supplier 180 is changed to the power saving state or the standby state, power consumption may be reduced. Moreover, if the active mode entry request WK1 is provided to the data storage device 140, the power supplier 180 may be changed to a normal state according to the control of the controller 160.

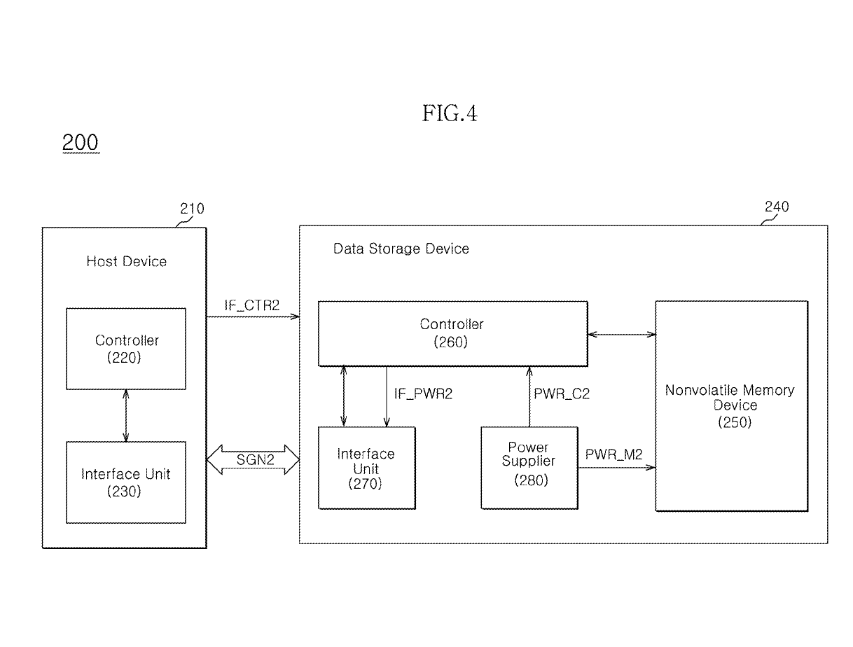

FIG. 4 is a block diagram showing examples of a data processing system in accordance with an embodiment of the present disclosure. Referring to FIG. 4, a data processing system 200 may include a host device 210, and a data storage device 240.

For instance, the host device 210 may include portable electronic devices such as a mobile phone, an MP3 player, a digital camera and a laptop computer, or electronic devices such as a desktop computer, a game player, a TV, a beam projector and a car entertainment system.

The host device 210 may include a controller 220 and an interface unit 230. While it is shown that the interface unit 230 is disposed outside the controller 220, it is to be noted that the interface unit 230 may be included in the controller 220.

The controller 220 may be configured to control the general operations of the host device 210. The controller 220 may control the general operations of the host device 210 through driving of a firmware or a software which is loaded on a working memory device (not shown).

The interface unit 230 may be configured to interface the host device 210 and the data storage device 240. For instance, the interface unit 230 may perform an interfacing function through one of various interface protocols such as an universal flash storage (UFS) protocol, an universal serial bus (USB) protocol, a multimedia card (MMC) protocol, a peripheral component interconnection (PCI) protocol, a PCI-express (PCI-E) protocol, a parallel advanced technology attachment (PATA) protocol, a serial advanced technology attachment (SATA) protocol, a small computer system interface (SCSI) protocol, and a serial attached SCSI (SAS) protocol.

The controller 220 may be configured to provide an access request (for example, a write request) and data to the data storage device 240, to store data in the data storage device 240. The controller 220 may be configured to provide an access request (for example, a read request) to the data storage device 240, to read data stored in the data storage device 240, and may be configured to be provided with data from the data storage device 240. Also, the controller 220 may be configured to provide various control requests for controlling the data storage device 240, which are not associated with the input and output of data, to the data storage device 240. Such access requests, data and control requests may be transferred to the data storage device 240 according to the protocol of the interface unit 230. Such access requests, data and control requests may be transmitted through a signal line SGN2 between the interface unit 230 of the host device 210 and an interface unit 270 of the data storage device 240.

The controller 220 may control the power saving mode of the host device 210. That is to say, the controller 220 may control the host device 210 to enter a power saving mode such as a sleep mode and a power-down mode when there is no task to be processed.

When the host device 210 enters the power saving mode, the controller 220 may control the data storage device 240 to also enter a power saving mode. For instance, the controller 220 may provide a power saving mode entry request as one of the control requests, to the data storage device 240. Further, when the host device 210 enters the power saving mode, the controller 220 may provide an interface control signal IF_CTR2 to the data storage device 240. Power supply to the interface unit 270 of the data storage device 240 may be interrupted by the interface control signal IF_CTR2.

The data storage device 240 may be configured to operate in response to a request from the host device 210. The data storage device 240 may be configured to store the data accessed by the host device 210. In other words, the data storage device 240 may be used as a memory device of the host device 210.

The data storage device 240 may be fabricated as any one of various kinds of storage devices, according to the protocol of the interface unit 270. For example, the data storage device 240 may be configured as any one of various kinds of storage devices such as a solid state drive, a multimedia card in the form of an MMC, an eMMC, an RS-MMC and a micro-MMC, a secure digital card in the form of an SD, a mini-SD and a micro-SD, an universal serial bus (USB) storage device, an universal flash storage (UFS) device, a personal computer memory card international association (PCMCIA) card, a compact flash (CF) card, a smart media card, and a memory stick.

The data storage device 240 may be fabricated as any one of various kinds of packages. For example, the data storage device 240 may be fabricated as any one of various kinds of package types such as a package on package (POP), a system in package (SIP), a system on chip (SOC), a multi-chip package (MCP), a chip on board (COB), a wafer-level fabricated package (WFP), and a wafer-level stack package (WSP).

The data storage device 240 may include a nonvolatile memory device 250, a controller 260, the interface unit 270, and a power supplier 280. While it is shown that the interface unit 270 and the power supplier 280 are disposed outside the controller 260, it is to be noted that the interface unit 270 and the power supplier 280 may be included in the controller 260.

The nonvolatile memory device 250 may operate as the storage medium of the data storage device 240. The nonvolatile memory device 250 may be constituted by any one of various types of nonvolatile memory devices such as a NAND type flash memory device, a NOR type flash memory device, a ferroelectric random access memory (FRAM) device using ferroelectric capacitors, a magnetic random access memory (MRAM) device using a tunneling magneto-resistive (TMR) layer, a phase change random access memory (PRAM) device using a chalcogenide alloy, and a resistive random access memory (ReRAM) device using a transition metal oxide. The nonvolatile memory device 250 may be constituted by a combination of a NAND type flash memory device and one or more of the various types of nonvolatile memory devices described above.

The controller 260 may be configured to control the general operations of the data storage device 240. The controller 260 may control the general operations of the data storage device 240 through driving of a firmware or a software which is loaded on a working memory device (not shown). The controller 260 may be configured to control the nonvolatile memory device 250 in response to a request from the host device 210. For example, the controller 260 may be configured to control the read, program (or write) and erase operations of the nonvolatile memory device 250.

The interface unit 270 may be configured to interface the data storage device 240 and the host device 210. For instance, the interface unit 270 may interface the data storage device 240 and the host device 210 through the same protocol as the protocol of the interface unit 230 of the host device 210.

The power supplier 280 may be configured to provide the external power inputted from an external device, to the inside of the data storage device 240. For example, the power supplier 280 may supply controller power PWR_C2 generated on the basis of the external power, to the controller 260. The power supplier 280 may supply memory power PWR_M2 generated on the basis of the external power, to the nonvolatile memory device 250. While not shown, the power supplier 280 may generate the controller power PWR_C2 and the memory power PWR_M2 according to the control signals provided from the controller 260.

The interface unit 270 may include a power block (not shown) for generating power to be used therein. The power block included in the interface unit 270 may supply or interrupt internal power in response to an interface power signal IF_PWR2 which is provided from the controller 260. For example, the power block included in the interface unit 270 may generate internal power when the interface power signal IF_PWR2 is activated, and may supply generated internal power to the interface unit 270. In other examples, the power block included in the interface unit 270 not only may not generate internal power but also may interrupt power being supplied to the function block of the interface unit 270, when the interface power signal IF_PWR2 is deactivated.

If the host device 210 activates the interface control signal IF_CTR2 when the operation of the interface unit 270 is not necessary, the controller 260 may deactivate the interface power signal IF_PWR2 according to the interface control signal IF_CTR2. Namely, the interface power signal IF_PWR2 may be provided to the interface unit 270 according to the interface control signal IF_CTR2 which is provided when the host device 210 operates at the power saving mode. This means that, while the host device 210 and the data storage device 240 operate at the power saving mode, power supply to the interface unit 270 is interrupted and thus the power consumed by the interface unit 270 may be reduced.

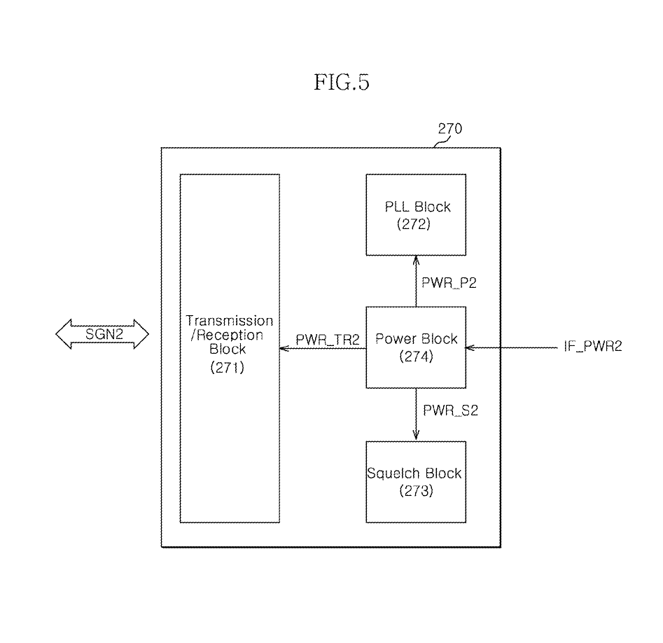

FIG. 5 is a block diagram showing examples of the interface unit included in the data storage device of FIG. 4.

The interface unit 270 may include a transmission/reception block 271, a phase-locked loop (PLL) block 272, a squelch block 273, and a power block 274.

The transmission/reception block 271 may be configured to generate a signal to be transmitted through the signal line SGN2 for signal transmission to the interface unit 230 of the host device 210, and transmit the generated signal. Also, the transmission/reception block 271 may be configured to receive the signal transmitted through the signal line SGN2.

The PLL block 272 may be configured to generate a clock which is needed for the signal transmission of the interface unit 270.

The squelch block 273 may be configured to sense the voltage level of the signal transmitted through the signal line SGN2, and determine whether the transmitted signal is a valid signal or an invalid signal (for example, noise), according to a sensing result.

The transmission/reception block 271, the PLL block 272 and the squelch block 273 may be physical blocks which include analog circuits. For this reason, the interface unit 270 may be referred to as a PHY unit (or a PHY block).

The power block 274 may be configured to generate power to be supplied to the internal function blocks 271, 272 and 273 of the interface unit 270, on the basis of the external power, and supply generated power. For example, the power block 274 may be configured to generate transmission/reception block power PWR_TR2, and supply the generated transmission/reception block power PWR_TR2 to the transmission/reception block 271. In other examples, the power block 274 may be configured to generate PLL block power PWR_P2, and supply the generated PLL block power PWR_P2 to the PLL block 272. In other examples, the power block 274 may be configured to generate squelch block power PWR_S2, and supply the generated squelch block power PWR_S2 to the squelch block 273.

The power block 274 may be configured to generate the power PWR_TR2, PWR_P2 and PWR_S2 to be supplied to the internal function blocks 271, 272 and 273 of the interface unit 270 according to the interface power signal IF_PWR2 which is provided from the controller 260, and supply the generated power PWR_TR2, PWR_P2 and PWR_S2 to the internal function blocks 271, 272 and 273. For example, the power block 274 may be configured to generate the power PWR_TR2, PWR_P2 and PWR_S2 and supply the generated power PWR_TR2, PWR_P2 and PWR_S2 to the respective internal function blocks 271, 272 and 273, when the interface power signal IF_PWR2 is activated. In other examples, the power block 274 not only may not generate the power PWR_TR2, PWR_P2 and PWR_S2 but also may interrupt the supply of the power PWR_TR2, PWR_P2 and PWR_S2, when the interface power signal IF_PWR2 is deactivated.

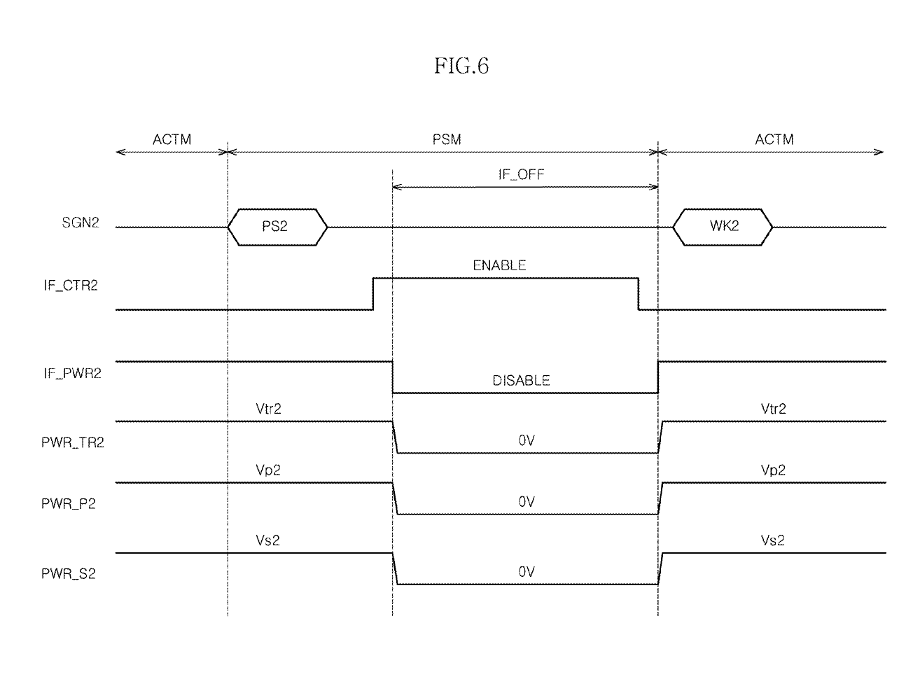

FIG. 6 is a timing diagram explaining operations of the data processing system of FIG. 4. The waveforms of control signals and the internal power of the interface unit 270 in the case where the host device 210 and the data storage device 240 operate in an active mode ACTM and a power saving mode PSM will be described below with reference to FIGS. 4 to 6.

In the case where the host device 210 is converted from the active mode ACTM into the power saving mode PSM, the controller 220 of the host device 210 may provide a power saving mode entry request PS2 to the data storage device 240. The power saving mode entry request PS2 may be provided in the form of a command through the signal line SGN2.

After the controller 220 of the host device 210 provides the power saving mode entry request PS2, it may activate (i.e., ENABLE) the interface control signal IF_CTR2 to reduce the power consumed by the interface unit 270 of the data storage device 240. Further, the controller 220 of the host device 210 may provide the activated interface control signal IF_CTR2 to the data storage device 240.

The controller 260 of the data storage device 240 may deactivate (i.e., DISABLE) the interface power signal IF_PWR2 when the activated interface control signal IF_CTR2 is provided. Also, the controller 260 of the data storage device 240 may provide the deactivated interface power signal IF_PWR2 to the interface unit 270.

When the deactivated interface power signal IF_PWR2 is provided, the power block 274 of the interface unit 270 not only may not generate the power PWR_TR2, PWR_P2 and PWR_S2 (for instance, 0V is shown) to be supplied to the internal function blocks 271, 272 and 273, but also may interrupt the power PWR_TR2, PWR_P2 and PWR_S2 being supplied to the internal function blocks 271, 272 and 273. While the power PWR_TR2, PWR_P2 and PWR_S2 to be supplied to the internal function blocks 271, 272 and 273 is shown as voltage values (Vtr2, Vp2 and Vs2 or a ground voltage of 0V) in FIG. 6, the power PWR_TR2, PWR_P2 and PWR_S2 may mean voltage or current values. If the power PWR_TR2, PWR_P2 and PWR_S2 to be supplied to the internal function blocks 271, 272 and 273 of the interface unit 270 is interrupted as in a period IF_OFF, since the interface unit 270 does not operate any more, the power consumed while the host device 210 and the data storage device 240 operate in the power saving mode PSM may be reduced.

In the case where the host device 210 is converted from the power saving mode PSM into the active mode ACTM, the controller 220 of the host device 210 may provide an active mode entry request WK2 to the data storage device 240. The active mode entry request WK2 may be provided in the form of a command through the signal line SGN2.

At the same time (or after) the controller 220 of the host device 210 provides the active mode entry request WK2, it may deactivate the interface control signal IF_CTR2 to allow the interface unit 270 of the data storage device 240 to operate. Further, the controller 220 of the host device 210 may provide the deactivated interface control signal IF_CTR2 to the data storage device 240.

The controller 260 of the data storage device 240 may activate the interface power signal IF_PWR2 when the deactivated interface control signal IF_CTR2 is provided. Also, the controller 260 of the data storage device 240 may provide the activated interface power signal IF_PWR2 to the interface unit 270.

The power block 274 of the interface unit 270 may generate the power PWR_TR2, PWR_P2 and PWR_S2 to be supplied to the internal function blocks 271, 272 and 273 when the activated interface power signal IF_PWR2 is provided, and may supply the generated power PWR_TR2, PWR_P2 and PWR_S2 to the respective internal function blocks 271, 272 and 273.

Although not shown, if the power saving mode entry request PS2 is provided to the data storage device 240, the power supplier 280 may be changed to a power saving state or a standby state according to the control of the controller 260. As the power supplier 280 is changed to the power saving state or the standby state, power consumption may be reduced. Moreover, if the active mode entry request WK2 is provided to the data storage device 240, the power supplier 280 may be changed to a normal state according to the control of the controller 260.

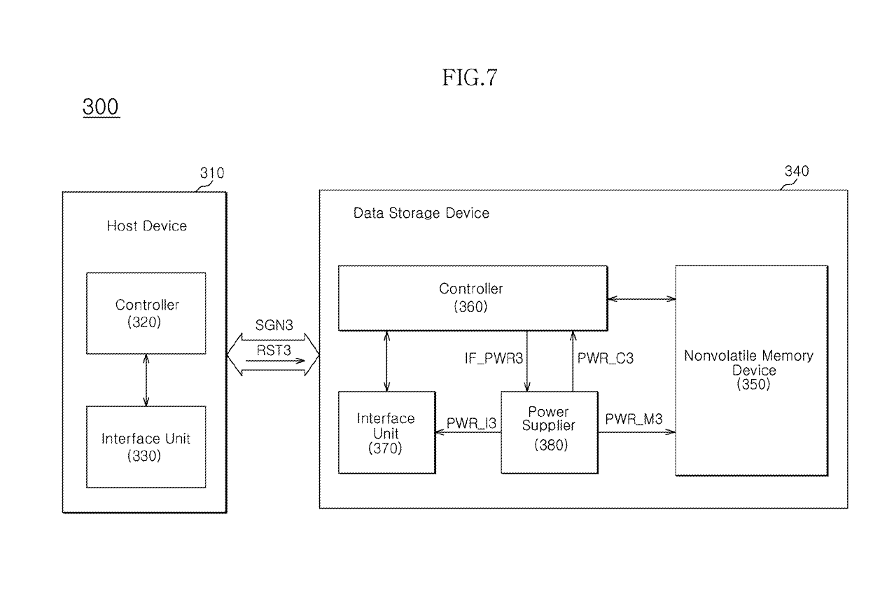

FIG. 7 is a block diagram showing examples of a data processing system in accordance with an embodiment of the present disclosure. Referring to FIG. 7, a data processing system 300 may include a host device 310, and a data storage device 340.

For instance, the host device 310 may include portable electronic devices such as a mobile phone, an MP3 player, a digital camera and a laptop computer, or electronic devices such as a desktop computer, a game player, a TV, a beam projector and a car entertainment system.

The host device 310 may include a controller 320 and an interface unit 330. While it is shown that the interface unit 330 is disposed outside the controller 320, it is to be noted that the interface unit 330 may be included in the controller 320.

The controller 320 may be configured to control the general operations of the host device 310. The controller 320 may control the general operations of the host device 310 through driving of a firmware or a software which is loaded on a working memory device (not shown).

The interface unit 330 may be configured to interface the host device 310 and the data storage device 340. For instance, the interface unit 330 may perform an interfacing function through one of various interface protocols such as an universal flash storage (UFS) protocol, an universal serial bus (USB) protocol, a multimedia card (MMC) protocol, a peripheral component interconnection (PCI) protocol, a PCI-express (PCI-E) protocol, a parallel advanced technology attachment (PATA) protocol, a serial advanced technology attachment (SATA) protocol, a small computer system interface (SCSI) protocol, and a serial attached SCSI (SAS) protocol.

The controller 320 may be configured to provide an access request (for example, a write request) and data to the data storage device 340, to store data in the data storage device 340. The controller 320 may be configured to provide an access request (for example, a read request) to the data storage device 340, to read data stored in the data storage device 340, and may be configured to be provided with data from the data storage device 340. Also, the controller 320 may be configured to provide various control requests for controlling the data storage device 340, which are not associated with the input and output of data, to the data storage device 340. Such access requests, data and control requests may be transferred to the data storage device 340 according to the protocol of the interface unit 330. Such access requests, data and control requests may be transmitted through a signal line SGN3 between the interface unit 330 of the host device 310 and an interface unit 370 of the data storage device 340.

The controller 320 may control the power saving mode of the host device 310. That is to say, the controller 320 may control the host device 310 to enter a power saving mode such as a sleep mode and a power-down mode when there is no task to be processed.

When the host device 310 enters the power saving mode, the controller 320 may control the data storage device 340 to also enter a power saving mode. For instance, the controller 320 may provide a power saving mode entry request as one of the control requests, to the data storage device 340. Power supply to the interface unit 370 of the data storage device 340 may be interrupted by the power saving mode entry request. In the case where the host device 310 enters an active mode from the power saving mode, the controller 320 may initialize or reset the data storage device 340. In this case, the controller 320 may provide a reset signal RST3 to the data storage device 340 through the signal line SGN3. Power supply to the interface unit 370 of the data storage device 340 may be restarted by the reset signal RST3.

The data storage device 340 may be configured to operate in response to a request from the host device 310. The data storage device 340 may be configured to store the data accessed by the host device 310. In other words, the data storage device 340 may be used as a memory device of the host device 310.

The data storage device 340 may be fabricated as any one of various kinds of storage devices, according to the protocol of the interface unit 370. For example, the data storage device 340 may be configured as any one of various kinds of storage devices such as a solid state drive, a multimedia card in the form of an MMC, an eMMC, an RS-MMC and a micro-MMC, a secure digital card in the form of an SD, a mini-SD and a micro-SD, an universal serial bus (USB) storage device, an universal flash storage (UFS) device, a personal computer memory card international association (PCMCIA) card, a compact flash (CF) card, a smart media card, and a memory stick.

The data storage device 340 may be fabricated as any one of various kinds of packages. For example, the data storage device 340 may be fabricated as any one of various kinds of package types such as a package on package (POP), a system in package (SIP), a system on chip (SOC), a multi-chip package (MCP), a chip on board (COB), a wafer-level fabricated package (WFP), and a wafer-level stack package WSP).

The data storage device 340 may include a nonvolatile memory device 350, a controller 360, the interface unit 370, and a power supplier 380. While it is shown that the interface unit 370 and the power supplier 380 are disposed outside the controller 360, it is to be noted that the interface unit 370 and the power supplier 380 may be included in the controller 360.

The nonvolatile memory device 350 may operate as the storage medium of the data storage device 340. The nonvolatile memory device 350 may be constituted by any one of various types of nonvolatile memory devices such as a NAND type flash memory device, a NOR type flash memory device, a ferroelectric random access memory (FRAM) device using ferroelectric capacitors, a magnetic random access memory (MRAM) device using a tunneling magneto-resistive (TMR) layer, a phase change random access memory (PRAM) device using a chalcogenide alloy, and a resistive random access memory (ReRAM) device using a transition metal oxide. The nonvolatile memory device 350 may be constituted by a combination of a NAND type flash memory device and one or more of the various types of nonvolatile memory devices described above.

The controller 360 may be configured to control the general operations of the data storage device 340. The controller 360 may control the general operations of the data storage device 340 through driving of a firmware or a software which is loaded on a working memory device (not shown). The controller 360 may be configured to control the nonvolatile memory device 350 in response to a request from the host device 310. For example, the controller 360 may be configured to control the read, program (or write) and erase operations of the nonvolatile memory device 350.

The interface unit 370 may be configured to interface the data storage device 340 and the host device 310. For instance, the interface unit 370 may perform an interfacing function through the same protocol as the protocol of the interface unit 330 of the host device 310.

The power supplier 380 may be configured to provide the external power inputted from an external device, to the inside of the data storage device 340. For example, the power supplier 380 may supply controller power PWR_C3 generated on the basis of the external power, to the controller 360. The power supplier 380 may supply memory power PWR_M3 generated on the basis of the external power, to the nonvolatile memory device 350. Moreover, the power supplier 380 may supply interface power PWR_I3 generated on the basis of the external power, to the interface unit 370.

The power supplier 380 may supply or interrupt the interface power PWR_I3 in response to an interface power signal IF_PWR3 which is provided from the controller 360. For example, the power supplier 380 may supply the interface power PWR_I3 to the interface unit 370 when the interface power signal IF_PWR3 is activated. In other examples, the power supplier 380 may interrupt the supply of the interface power PWR_I3 when the interface power signal IF_PWR3 is deactivated.

In the case where the host device 310 enters the power saving mode, the operation of the interface unit 370 may not be necessary. If the host device 310 provides the power saving mode entry signal, the controller 360 may deactivate the interface power signal IF_PWR3 according to the power saving mode entry signal. Namely, the interface power signal IF_PWR3 may be provided to the power supplier 380 according to the power saving mode entry signal which is provided when the host device 310 operates at the power saving mode. This means that, while the host device 310 and the data storage device 340 operate at the power saving mode, power supply to the interface unit 370 is interrupted and thus the power consumed by the interface unit 370 may be reduced.

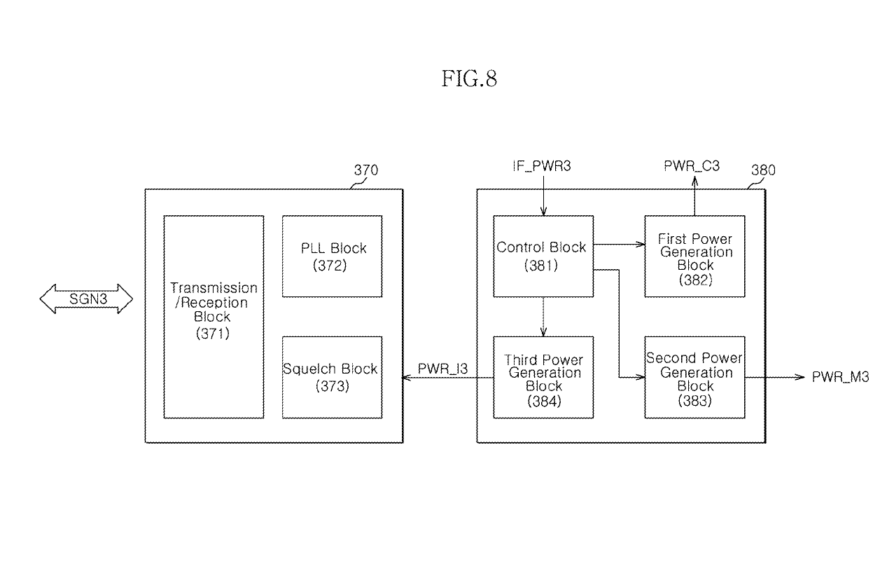

FIG. 8 is a block diagram showing examples of the interface unit and the power supplier included in the data storage device of FIG. 7.

The interface unit 370 may include a transmission/reception block 371, a phase-locked loop (PLL) block 372, and a squelch block 373.

The transmission/reception block 371 may be configured to generate a signal to be transmitted through the signal line SGN3 for signal transmission to the interface unit 330 of the host device 310, and transmit the generated signal. Also, the transmission/reception block 371 may be configured to receive the signal transmitted through the signal line SGN3.

The PLL block 372 may be configured to generate a clock which is needed for the signal transmission of the interface unit 370.

The squelch block 373 may be configured to sense the voltage level of the signal transmitted through the signal line SGN3, and determine whether the transmitted signal is a valid signal or an invalid signal (for example, noise), according to a sensing result.

The transmission/reception block 371, the PLL block 372 and the squelch block 373 may be physical blocks which include analog circuits. For this reason, the interface unit 370 may be referred to as a PHY unit (or a PHY block).

The power supplier 380 may include a control block 381, a first power generation block 382, a second power generation block 383, and a third power generation block 384.

The control block 381 may be configured to control the first power generation block 382 according to a control signal (not shown) provided from the controller 360. The first power generation block 382 may be configured to generate the controller power PWR_C3 according to the control of the control block 381, and supply the generated controller power PWR_C3 to the controller 360.

The control block 381 may be configured to control the second power generation block 383 according to a control signal (not shown) provided from the controller 360. The second power generation block 383 may be configured to generate the memory power PWR_M3 according to the control of the control block 381, and supply the generated memory power PWR_M3 to the nonvolatile memory device 350.

The control block 381 may be configured to control the third power generation block 384 according to the interface power signal IF_PWR3 provided from the controller 360. The third power generation block 384 may be configured to generate the interface power PWR_I3 when the interface power signal IF_PWR3 is activated, and supply the generated interface power PWR_I3 to the interface unit 370. The third power generation block 384 not only may not generate the interface power PWR_I3 but also may interrupt the supply of the interface power PWR_I3, when the interface power signal IF_PWR3 is deactivated.

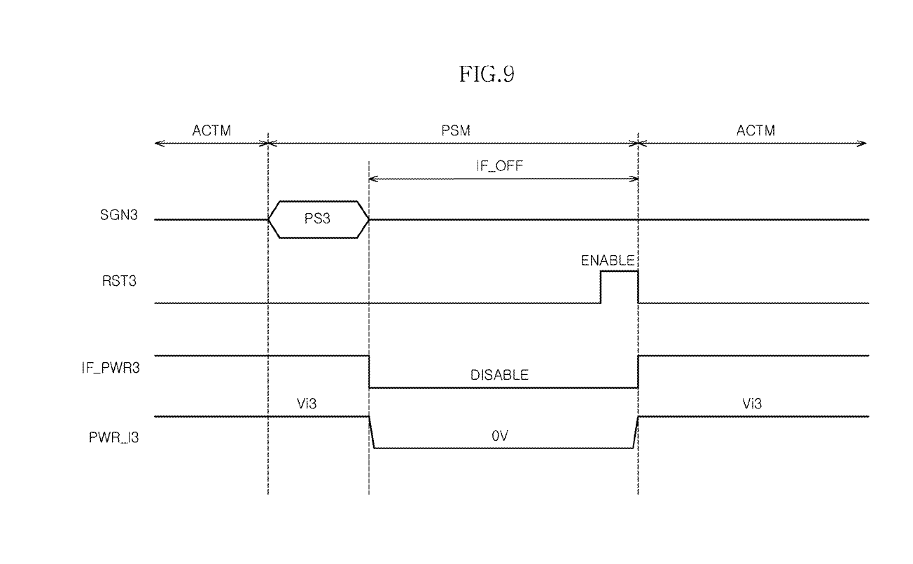

FIG. 9 is a timing diagram explaining operations of the data processing system of FIG. 7. The waveforms of control signals and power in the case where the host device 310 and the data storage device 340 operate in an active mode ACTM and a power saving mode PSM will be described below with reference to FIGS. 7 to 9.

In the case where the host device 310 is converted from the active mode ACTM into the power saving mode PSM, the controller 320 of the host device 310 may provide a power saving mode entry request PS3 to the data storage device 340. The power saving mode entry request PS3 may be provided in the form of a command through the signal line SGN3.

The controller 360 of the data storage device 340 may deactivate (i.e., DISABLE) the interface power signal IF_PWR3 when the power saving mode entry request PS3 is provided. Also, the controller 360 of the data storage device 340 may provide the deactivated interface power signal IF_PWR3 to the power supplier 380.

When the deactivated interface power signal IF_PWR3 is provided, the power supplier 380 not only may not generate the interface power PWR_I3 (for instance, 0V is shown), but also may interrupt the interface power PWR_I3 being supplied to the interface unit 370. While the interface power PWR_I3 is shown as a voltage value (Vi3 or a ground voltage of 0V) in FIG. 9, the interface power PWR_I3 may mean a voltage or current value. If the interface power PWR_I3 supplied to the interface unit 370 is interrupted as in a period IF_OFF, since the interface unit 370 does not operate any more, the power consumed while the host device 310 and the data storage device 340 operate in the power saving mode PSM may be reduced.

In the case where the host device 310 is converted from the power saving mode PSM into the active mode ACTM, the controller 320 of the host device 310 may reset (or initialize) the data storage device 340. In this case, the controller 320 may provide the activated reset signal RST3 (i.e., ENABLE) to the data storage device 340 through the signal line SGN3.

The controller 360 of the data storage device 340 may perform a reset (or initializing) operation in response to the reset signal RST3. If the reset (or initializing) operation is performed, the deactivated interface power signal IF_PWR3 may be activated to an initialized state. The controller 360 of the data storage device 340 may provide the activated interface power signal IF_PWR3 to the power supplier 380 after the reset (or initializing) operation.

When the activated interface power signal IF_PWR3 is provided, the power supplier 380 may generate the interface power PWR_I3, and may supply the generated interface power PWR_I3 to the interface unit 370. That is to say, power may be supplied again to the interface unit 370 of the data storage device 340 by the reset signal RST3.

Although not shown, if the power saving mode entry request PS3 is provided to the data storage device 340, the power supplier 380 may be changed to a power saving state or a standby state according to the control of the controller 360. As the power supplier 380 is changed to the power saving state or the standby state, power consumption may be reduced. Moreover, if the reset signal RST3 is provided to the data storage device 340, the power supplier 380 may be changed to an initialized state or a normal state according to the control of the controller 360.

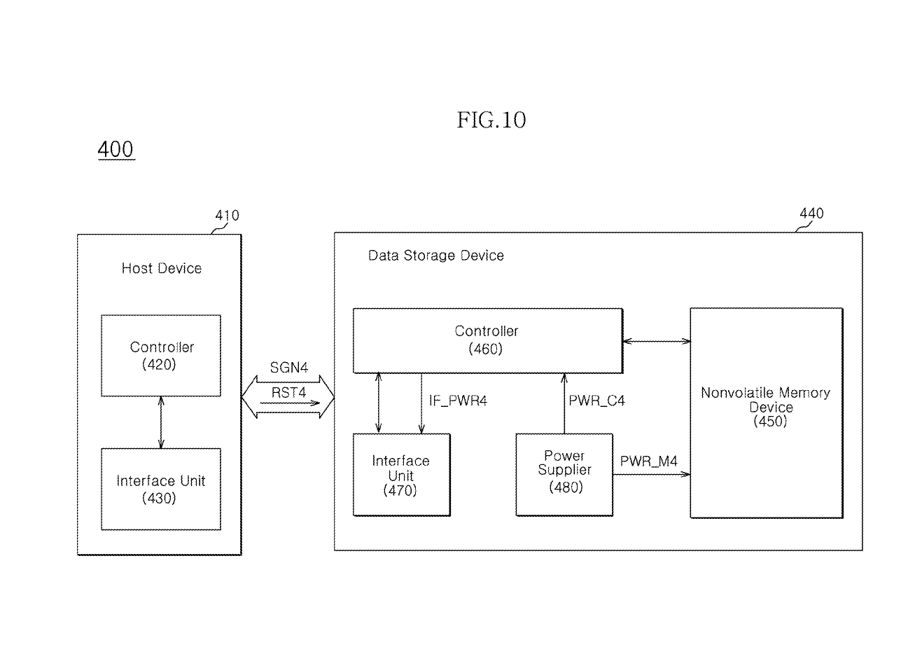

FIG. 10 is a block diagram showing examples of a data processing system in accordance with an embodiment of the present disclosure. Referring to FIG. 10, a data processing system 400 may include a host device 410, and a data storage device 440.

For instance, the host device 410 may include portable electronic devices such as a mobile phone, an MP3 player, a digital camera and a laptop computer, or electronic devices such as a desktop computer, a game player, a TV, a beam projector and a car entertainment system.

The host device 410 may include a controller 420 and an interface unit 430. While it is shown that the interface unit 430 is disposed outside the controller 420, it is to be noted that the interface unit 430 may be included in the controller 420.

The controller 420 may be configured to control the general operations of the host device 410. The controller 420 may control the general operations of the host device 410 through driving of a firmware or a software which is loaded on a working memory device (not shown).

The interface unit 430 may be configured to interface the host device 410 and the data storage device 440. For instance, the interface unit 430 may perform an interfacing function through one of various interface protocols such as an universal flash storage (UFS) protocol, an universal serial bus (USB) protocol, a multimedia card (MMC) protocol, a peripheral component interconnection (PCI) protocol, a PCI-express (PCI-E) protocol, a parallel advanced technology attachment (PATA) protocol, a serial advanced technology attachment (SATA) protocol, a small computer system interface (SCSI) protocol, and a serial attached SCSI (SAS) protocol.

The controller 420 may be configured to provide an access request (for example, a write request) and data to the data storage device 440, to store data in the data storage device 440. The controller 420 may be configured to provide an access request (for example, a read request) to the data storage device 440, to read data stored in the data storage device 440, and may be configured to be provided with data from the data storage device 440. Also, the controller 420 may be configured to provide various control requests for controlling the data storage device 440, which are not associated with the input and output of data, to the data storage device 440. Such access requests, data and control requests may be transferred to the data storage device 440 according to the protocol of the interface unit 430. Such access requests, data and control requests may be transmitted through a signal line SGN4 between the interface unit 430 of the host device 410 and an interface unit 470 of the data storage device 440.

The controller 420 may control the power saving mode of the host device 410. That is to say, the controller 420 may control the host device 410 to enter a power saving mode such as a sleep mode and a power-down mode when there is no task to be processed.

When the host device 410 enters the power saving mode, the controller 420 may control the data storage device 440 to also enter a power saving mode. For instance, the controller 420 may provide a power saving mode entry request as one of the control requests, to the data storage device 440. Power supply to the interface unit 470 of the data storage device 440 may be interrupted by the power saving mode entry request. In the case where the host device 410 enters an active mode from the power saving mode, the controller 420 may initialize or reset the data storage device 440. In this case, the controller 420 may provide a reset signal RST4 to the data storage device 440 through the signal line SGN4. Power supply to the interface unit 470 of the data storage device 440 may be restarted by the reset signal RST4.

The data storage device 440 may be configured to operate in response to a request from the host device 410. The data storage device 440 may be configured to store the data accessed by the host device 410. In other words, the data storage device 440 may be used as a memory device of the host device 410.

The data storage device 440 may be fabricated as any one of various kinds of storage devices, according to the protocol of the interface unit 470. For example, the data storage device 440 may be configured as any one of various kinds of storage devices such as a solid state drive, a multimedia card in the form of an MMC, an eMMC, an RS-MMC and a micro-MMC, a secure digital card in the form of an SD, a mini-SD and a micro-SD, an universal serial bus (USB)_storage device, an universal flash storage (UFS) device, a personal computer memory card international association (PCMCIA) card, a compact flash (CF) card, a smart media card, and a memory stick.

The data storage device 440 may be fabricated as any one of various kinds of packages. For example, the data storage device 440 may be fabricated as any one of various kinds of package types such as a package on package (POP), a system in package (SIP), a system on chip (SOC), a multi-chip package (MCP), a chip on board (COB), a wafer-level fabricated package (WFP), and a wafer-level stack package (WSP).

The data storage device 440 may include a nonvolatile memory device 450, a controller 460, the interface unit 470, and a power supplier 480. While it is shown that the interface unit 470 and the power supplier 480 are disposed outside the controller 460, it is to be noted that the interface unit 470 and the power supplier 480 may be included in the controller 460.

The nonvolatile memory device 450 may operate as the storage medium of the data storage device 440. The nonvolatile memory device 450 may be constituted by any one of various types of nonvolatile memory devices such as a NAND type flash memory device, a NOR type flash memory device, a ferroelectric random access memory (FRAM) device using ferroelectric capacitors, a magnetic random access memory (MRAM) device using a tunneling magneto-resistive (TMR) layer, a phase change random access memory (PRAM) device using a chalcogenide alloy, and a resistive random access memory (ReRAM) device using a transition metal oxide. The nonvolatile memory device 450 may be constituted by a combination of a NAND type flash memory device and one or more of the various types of nonvolatile memory devices described above.

The controller 460 may be configured to control the general operations of the data storage device 440. The controller 460 may control the general operations of the data storage device 440 through driving of a firmware or a software which is loaded on a working memory device (not shown). The controller 460 may be configured to control the nonvolatile memory device 450 in response to a request from the host device 410. For example, the controller 460 may be configured to control the read, program (or write) and erase operations of the nonvolatile memory device 450.

The interface unit 470 may be configured to interface the data storage device 440 and the host device 410. For instance, the interface unit 470 may perform an interfacing function through the same protocol as the protocol of the interface unit 430 of the host device 410.

The power supplier 480 may be configured to provide the external power inputted from an external device, to the inside of the data storage device 440. For example, the power supplier 480 may supply controller power PWR_C4 generated on the basis of the external power, to the controller 460. The power supplier 480 may supply memory power PWR_M4 generated on the basis of the external power, to the nonvolatile memory device 450. While not shown, the power supplier 480 may generate the controller power PWR_C4 and the memory power PWR_M4 according to the control signals provided from the controller 460.

The interface unit 470 may include a power block (not shown) for generating power to be used therein. The power block included in the interface unit 470 may supply or interrupt internal power in response to an interface power signal IF_PWR4 which is provided from the controller 460. For example, the power block included in the interface unit 470 may generate internal power when the interface power signal IF_PWR4 is activated, and may supply generated internal power to the interface unit 470. In other examples, the power block included in the interface unit 470 not only may not generate internal power but also may interrupt power being supplied to the function block of the interface unit 470, when the interface power signal IF_PWR4 is deactivated.

In the case where the host device 410 enters the power saving mode, the operation of the interface unit 470 may not be necessary. If the host device 410 provides the power saving mode entry signal, the controller 460 may deactivate the interface power signal IF_PWR4 according to the power saving mode entry signal. Namely, the interface power signal IF_PWR4 may be provided to the interface unit 470 according to the power saving mode entry signal which is provided when the host device 410 operates at the power saving mode. This means that, while the host device 410 and the data storage device 440 operate at the power saving mode, power supply to the interface unit 470 is interrupted and thus the power consumed by the interface unit 470 may be reduced.

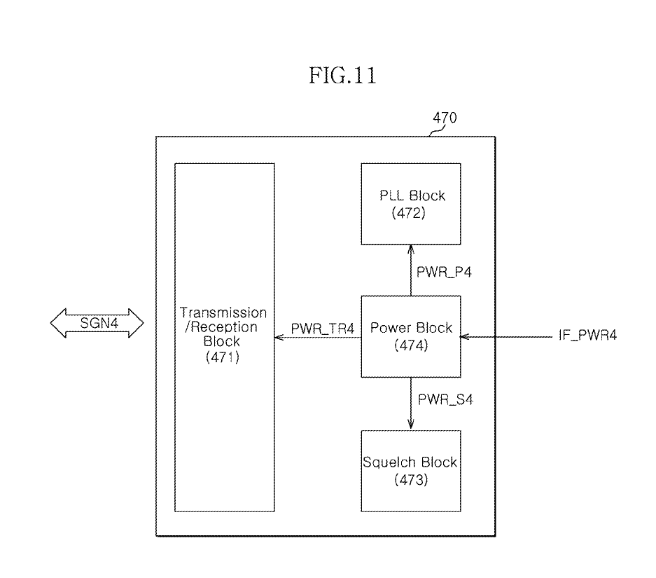

FIG. 11 is a block diagram showing examples of the interface unit included in the data storage device of FIG. 10.

The interface unit 470 may include a transmission/reception block 471, a phase-locked loop (PLL) block 472, a squelch block 473, and a power block 474.

The transmission/reception block 471 may be configured to generate a signal to be transmitted through the signal line SGN4 for signal transmission to the interface unit 430 of the host device 410, and transmit the generated signal. Also, the transmission/reception block 471 may be configured to receive the signal transmitted through the signal line SGN4.

The PLL block 472 may be configured to generate a clock which is needed for the signal transmission of the interface unit 470.

The squelch block 473 may be configured to sense the voltage level of the signal transmitted through the signal line SGN4, and determine whether the transmitted signal is a valid signal or an invalid signal (for example, noise), according to a sensing result.

The transmission/reception block 471, the PLL block 472 and the squelch block 473 may be physical blocks which include analog circuits. For this reason, the interface unit 470 may be referred to as a PHY unit (or a PHY block).

The power block 474 may be configured to generate power to be supplied to the internal function blocks 471, 472 and 473 of the interface unit 470, on the basis of the external power, and supply generated power. For example, the power block 474 may be configured to generate transmission/reception block power PWR_TR4, and supply the generated transmission/reception block power PWR_TR4 to the transmission/reception block 471. In other examples, the power block 474 may be configured to generate PLL block power PWR_P4, and supply the generated PLL block power PWR_P4 to the PLL block 472. In other examples, the power block 474 may be configured to generate squelch block power PWR_S4, and supply the generated squelch block power PWR_S4 to the squelch block 473.

The power block 474 may be configured to generate the power PWR_TR4, PWR_P4 and PWR_S4 to be supplied to the internal function blocks 471, 472 and 473 of the interface unit 470 according to the interface power signal IF_PWR4 which is provided from the controller 460, and supply the generated power PWR_TR4, PWR_P4 and PWR_S4 to the internal function blocks 471, 472 and 473. For example, the power block 474 may be configured to generate the power PWR_TR4, PWR_P4 and PWR_S4 and supply the generated power PWR_TR4, PWR_P4 and PWR_S4 to the respective internal function blocks 471, 472 and 473, when the interface power signal IF_PWR4 is activated. In other examples, the power block 474 not only may not generate the power PWR_TR4, PWR_P4 and PWR_S4 but also may interrupt the supply of the power PWR_TR4, PWR_P4 and PWR_S4, when the interface power signal IF_PWR4 is deactivated.

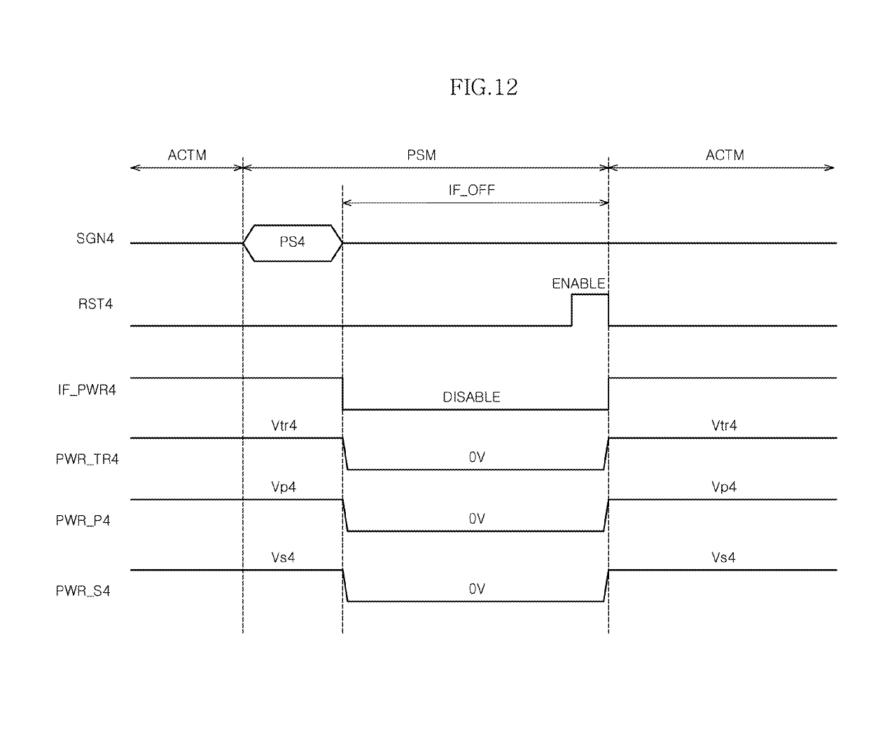

FIG. 12 is a timing diagram explaining operations of the data processing system of FIG. 10. The waveforms of control signals and the internal power of the interface unit 470 in the case where the host device 410 and the data storage device 440 operate in an active mode ACTM and a power saving mode PSM will be exemplarily described below with reference to FIGS. 10 to 12.

In the case where the host device 410 is converted from the active mode ACTM into the power saving mode PSM, the controller 420 of the host device 410 may provide a power saving mode entry request PS4 to the data storage device 440. The power saving mode entry request PS4 may be provided in the form of a command through the signal line SGN4.

The controller 460 of the data storage device 440 may deactivate (i.e., DISABLE) the interface power signal IF_PWR4 when the power saving mode entry request PS4 is provided. Also, the controller 460 of the data storage device 440 may provide the deactivated interface power signal IF_PWR4 to the interface unit 470.

When the deactivated interface power signal IF_PWR4 is provided, the power block 474 of the interface unit 470 not only may not generate the power PWR_TR4, PWR_P4 and PWR_S4 (for instance, 0V is shown) to be supplied to the internal function blocks 471, 472 and 473, but also may interrupt the power PWR_TR4, PWR_P4 and PWR_S4 being supplied to the internal function blocks 471, 472 and 473. While the power PWR_TR4, PWR_P4 and PWR_S4 to be supplied to the internal function blocks 471, 472 and 473 is shown as voltage values (Vtr4, Vp4 and Vs4 or a ground voltage of 0V) in FIG. 12, the power PWR_TR4, PWR_P4 and PWR_S4 may mean voltage or current values. If the power PWR_TR4, PWR_P4 and PWR_S4 to be supplied to the internal function blocks 471, 472 and 473 of the interface unit 470 is interrupted as in a period IF_OFF, since the interface unit 470 does not operate any more, the power consumed while the host device 410 and the data storage device 440 operate in the power saving mode PSM may be reduced.

In the case where the host device 410 is converted from the power saving mode PSM into the active mode ACTM, the controller 420 of the host device 410 may reset (or initialize) the data storage device 440. In this case, the controller 420 may provide the activated (i.e., ENABLE) reset signal RST4 to the data storage device 440 through the signal line SGN4.

The controller 460 of the data storage device 440 may perform a reset (or initializing) operation in response to the reset signal RST4. If the reset (or initializing) operation is performed, the deactivated interface power signal IF_PWR4 may be activated to an initialized state. The controller 460 of the data storage device 440 may provide the activated interface power signal IF_PWR4 to the interface unit 470 after the reset (or initializing) operation.

The power block 474 of the interface unit 470 may generate the power PWR_TR4, PWR_P4 and PWR_S4 to be supplied to the internal function blocks 471, 472 and 473 when the activated interface power signal IF_PWR4 is provided, and may supply the generated power PWR_TR4, PWR_P4 and PWR_S4 to the respective internal function blocks 471, 472 and 473.

Although not shown, if the power saving mode entry request PS4 is provided to the data storage device 440, the power supplier 480 may be changed to a power saving state or a standby state according to the control of the controller 460. As the power supplier 480 is changed to the power saving state or the standby state, power consumption may be reduced. Moreover, if the reset signal RST4 is provided to the data storage device 440, the power supplier 480 may be changed to an initialized state or a normal state according to the control of the controller 460.

While various embodiments have been described above, it will be understood to those skilled in the art that the embodiments described are by way of example only. Accordingly, the data storage device and the data processing system including the same described herein should not be limited based on the described embodiments. Rather, the data storage device and the data processing system including the same described herein should only be limited in light of the claims that follow when taken in conjunction with the above description and accompanying drawings.

What is claimed is:

1. A data processing system comprising:
a host device; and
a data storage device including an interface unit which is configured to interface with the host device, and configured to store data provided from the host device or provide data to the host device, in response to a request from the host device,
wherein the data storage device is configured to interrupt power supply to the interface unit while the host device operates in a power saving mode.

2. The data processing system according to claim 1,
wherein the host device is configured to activate an interface control signal while operating in the power saving mode, and
wherein the data storage device is configured to interrupt power supply to the interface unit according to the activated interface control signal.

3. The data processing system according to claim 2, wherein the host device is configured to provide a power saving mode entry request for controlling the data storage device to operate in the power saving mode, to the data storage device when the host device is converted from an active mode to the power saving mode.

4. The data processing system according to claim 3, wherein the host device is configured to activate the interface control signal after providing the power saving mode entry request.

5. The data processing system according to claim 1,
wherein the host device is configured to deactivate the interface control signal while operating in an active mode, and
wherein the data storage device is configured to supply power to the interface unit according to the deactivated interface control signal.

6. The data processing system according to claim 5, wherein the host device is configured to provide an active mode entry request for controlling the data storage device to operate in the active mode, to the data storage device when the host device is converted from the power saving mode to the active mode.

7. The data processing system according to claim 6, wherein the host device is configured to deactivate the interface control signal at the same time with providing the active mode entry request.

8. The data processing system according to claim 1, wherein the host device is configured to provide a reset signal for resetting the data storage device when being converted from the power saving mode to an active mode.

9. The data processing system according to claim 8, wherein the data storage device is configured to restart a power supply to the interface unit, according to the reset signal.

10. A data storage device comprising:
a nonvolatile memory device;
a controller configured to store data provided from a host device, in the nonvolatile memory device, or provide data read from the nonvolatile memory device, to the host device, in response to a request from the host device;
an interface unit configured to interface the host device and the controller; and
a power supplier configured to supply power to the nonvolatile memory device, the controller and the interface unit according to control of the controller,
wherein the controller is configured to control the power supplier in such a manner that power supply to the interface unit is interrupted while operating in a power saving mode.

11. The data storage device according to claim 10,
wherein the controller deactivates an interface power signal for controlling power supply to the interface unit, after a power saving mode entry request is provided from the host device, and
wherein the power supplier is configured to not generate power to be supplied to the interface unit, according to the deactivated interface power signal.

12. The data storage device according to claim 11, wherein the controller is configured to deactivate the interface power signal according to an activated interface control signal which is provided from the host device after the power saving mode entry request is provided.

13. The data storage device according to claim 11,
wherein the controller activates the interface power signal after an active mode entry request is provided from the host device, and
wherein the power supplier is configured to restart power supply to the interface unit according to the activated interface power signal.

14. The data storage device according to claim 11,
wherein the controller activates the interface power signal when a reset signal is provided from the host device, and
wherein the power supplier is configured to restart power supply to the interface unit according to the activated interface power signal.

15. A data storage device comprising:
a nonvolatile memory device;
a controller configured to store data provided from a host device, in the nonvolatile memory device, or provide data read from the nonvolatile memory device, to the host device, in response to a request from the host device; and
an interface unit including a power block for generating power to be internally used, and configured to interface the host device and the controller,
wherein the controller is configured to control the power block in such a manner that power supply to the interface unit is interrupted while operating in a power saving mode.

16. The data storage device according to claim 15,
wherein the controller deactivates an interface power signal for controlling power supply to the interface unit, after a power saving mode entry request is provided from the host device, and
wherein the power block is configured to not generate power to be supplied to a function block of the interface unit, according to the deactivated interface power signal.

17. The data storage device according to claim 16, wherein the controller is configured to deactivate the interface power signal according to an activated interface control signal which is provided from the host device after the power saving mode entry request is provided.

18. The data storage device according to claim 16,
wherein the controller activates the interface power signal after an active mode entry request is provided from the host device, and
wherein the power block is configured to restart power supply to the function block of the interface unit according to the activated interface power signal.

19. The data storage device according to claim 16,
wherein the controller activates the interface power signal when to a reset signal is provided from the host device, and
wherein the power block is configured to restart power supply to the function block of the interface unit according to the activated interface power signal.

20. The data storage device according to claim 15, further comprising:
a power supplier configured to supply power to the nonvolatile memory device and the controller according to control of the controller.
